(19) United States
(12) Patent Application Publication
(10) Pub. No.: US 2026/0228264 A1
(43) Pub. Date: Aug. 6, 2026

(54) COMPUTING DEVICE AND COMPUTING METHOD

(71) Applicant: Hitachi, Ltd., Tokyo (JP)

(72) Inventors: Giada CONFORTOLA, Tokyo (JP); Satoru WATANABE, Tokyo (JP)

(73) Assignee: Hitachi, Ltd., Tokyo (JP)

(21) Appl. No.: 19/312,705

(22) Filed: Aug. 28, 2025

(30) Foreign Application Priority Data
Feb. 4, 2025 (JP) 2025-017146

(51) Int. Cl. G06F 16/334; G06F 16/38; G06F 40/279

(52) U.S. Cl. CPC G06F 16/3347; G06F 16/38; G06F 40/279

(57) ABSTRACT

A computing device includes: a processor executing a program; a storage device storing the program; and a document set communicating unit capable of accessing a document set including documents collected in advance. The storage device further stores a metadata DB specifying a corresponding relationship between each of the documents in the document set and a keyword being at least one word, and the processor performs: keyword extracting processing of extracting an extracted keyword being a word, from a user prompt being a question entered by a user; first narrowing-down processing of narrowing down the documents in the document set based on similarity between the user prompt and the documents; second narrowing-down processing of narrowing down the documents in the document set based on the extracted keyword and the metadata DB; and integrated narrowing-down processing of narrowing down the documents in the document set using the first and second narrowing-down processing.

### BACKGROUND OF THE INVENTION

### Field of the Invention

The present invention relates to a computing device and a computing method.

### Description of the Related Art

A retrieval-augmented generation (RAG) is a combination of retrieval with generation, and generation is performed using documents collected in the retrieval phase. US 2024/0134915 A discloses a configuration for improving the efficiency of data retrieval by integrating a plurality of data taxonomies.

### SUMMARY OF THE INVENTION

In the invention described in US 2024/0134915 A, there is room for improvement in the retrieval of related documents.

A computing device according to a first aspect of the present invention is a computing device including: a processor that executes a program; a storage device that stores the program; and a document set communicating unit that is capable of accessing a document set including a plurality of documents collected in advance, in which the storage device further stores a metadata DB specifying a corresponding relationship between each of the documents included in the document set and a keyword that is at least one word, and the processor is configured to perform: keyword extracting processing of extracting an extracted keyword that is a word, from a user prompt that is a question entered by a user; first narrowing-down processing of narrowing down the documents in the document set based on similarity between the user prompt and the documents; second narrowing-down processing of narrowing down the documents in the document set based on the extracted keyword and the metadata DB; and integrated narrowing-down processing of narrowing down the documents in the document set using the first narrowing-down processing and the second narrowing-down processing.

A computing method according to a second aspect of the present invention is a computing method executed by a computer including: a document set communicating unit that is capable of accessing a document set including a plurality of documents collected in advance; and a metadata database specifying a corresponding relationship between each of the documents included in the document set and at least one keyword, the computing method including: keyword extracting processing of extracting an extracted keyword that is a word, from a user prompt that is a question entered by a user; first narrowing-down processing of narrowing down the documents in the document set based on similarity between the user prompt and the documents; second narrowing-down processing of narrowing down the documents in the document set based on the extracted keyword and keywords associated with the documents; and integrated narrowing-down processing of narrowing down the documents in the document set using the first narrowing-down processing and the second narrowing-down processing.

According to the present invention, retrieval of related documents can be improved.

### BRIEF DESCRIPTION OF THE DRAWINGS

FIG. 1 is a functional configuration diagram of a computing device 1 according to a first embodiment;

FIG. 2 is a hardware configuration diagram of the computing device 1;

FIG. 3 is a diagram illustrating an example of data stored in each database;

FIG. 4 is a diagram illustrating a correlation relationship between pieces of data;

FIG. 5 is a diagram illustrating correlation between data and processing, involved in response-generating processing according to the first embodiment;

FIG. 6 is a flowchart illustrating database creating processing;

FIG. 7 is a flowchart illustrating response-generating processing;

FIG. 8 is a diagram illustrating a data upload window;

FIG. 9 is a diagram illustrating a keyword edit window;

FIG. 10 is a diagram illustrating a detail designating window;

FIG. 11 is a diagram illustrating a correlation relationship between pieces of data in a first modification;

FIG. 12 is a diagram illustrating a correlation between pieces of data in the first embodiment and the first modification;

FIG. 13 is a functional configuration diagram of a computing device according to a second embodiment;

FIG. 14 is a diagram illustrating correlations between data and processing, involved in response-generating processing according to the second embodiment; and

FIG. 15 is a flowchart illustrating the response-generating processing according to the second embodiment.

### DESCRIPTION OF THE PREFERRED EMBODIMENTS

### First embodiment

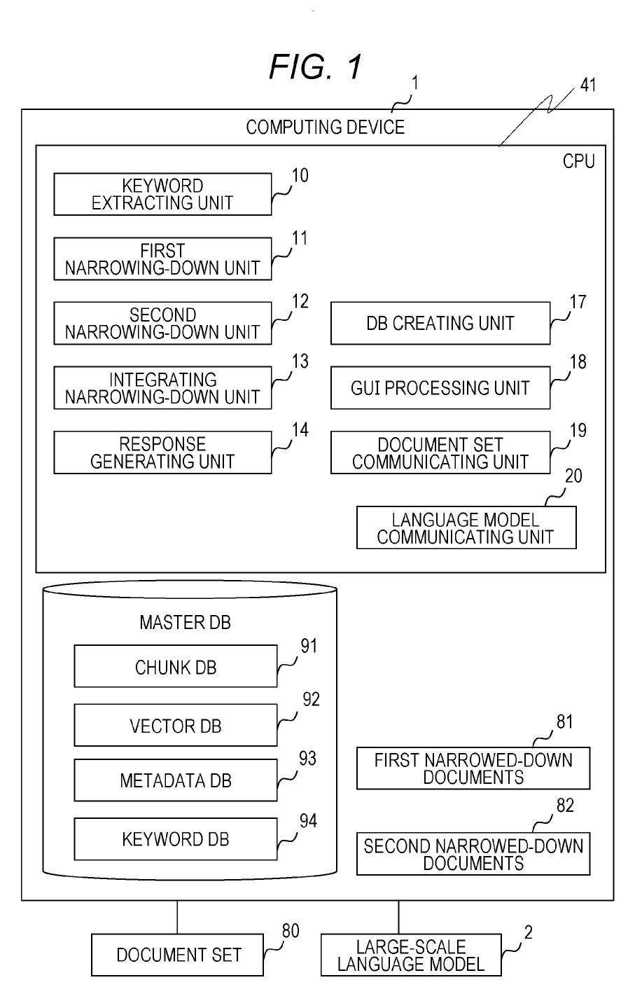

A computing device and a computing method according to a first embodiment will now be described with reference to FIGS. 1 to 10.

FIG. 1 is a functional configuration diagram of a computing device 1. FIG. 1 also illustrates data stored in the computing device 1. Hereinafter, a person who uses the computing device 1 will be referred to as a “user”. The computing device 1 includes a keyword extracting unit 10, a first narrowing-down unit 11, a second narrowing-down unit 12, an integrating narrowing-down unit 13, a response generating unit 14, a DB creating unit 17, a GUI processing unit 18, a document set communicating unit 19, and a language model communicating unit 20 that are implemented by using a CPU 41. The computing device 1 also stores therein a master database 90, first narrowed-down documents 81, and second narrowed-down documents 82. In the description herein and the drawings, the “database” will be also referred to as a “DB”.

The computing device 1 can access a document set 80 and a large-scale language model 2 via communication. It is also possible for the document set 80 and the large-scale language model 2 to be provided on the computing device 1. In FIG. 1, the master database 90 is illustrated as being provided internal of the computing device 1, but the master DB 90 only needs to be accessible from the computing device 1. For example, the entire or a part of the master database 90 may be located external of the computing device 1, and the computing device 1 may read and write the master DB 90 via communication. The same applies to the first narrowed-down documents 81 and the second narrowed-down documents 82; the configuration having these documents located internal of the computing device 1 is not an essential configuration, and these documents only need to be readable and writable from the computing device 1.

The keyword extracting unit 10 extracts a keyword from a document. The keyword extracting unit 10 can extract keywords using various known methods. For example, rule-based extraction, machine learning, or large-scale language model 2 may be used. The rule-based extraction is, for example, frequency-based or dictionary-based keyword extraction. The machine learning can be implemented by training a keyword extraction model using training data, for example. When the large-scale language model 2 is used, for example, a character string “Please extract a keyword from the following document” and a document are input to the large-scale language model 2.

The first narrowing-down unit 11 obtains first narrowed-down documents 81, by narrowing down the document set 80 that is a set of documents designated by the integrating narrowing-down unit 13, using a method to be described later. The narrowing-down of documents executed by the first narrowing-down unit 11 includes vector search, as will be described later, and this processing will be also referred to as retrieval processing 61. The second narrowing-down unit 12 obtains second narrowed-down documents 82, by narrowing down the first narrowed-down documents 81 that are the documents designated by the integrating narrowing-down unit 13, using a method to be described later. Because the narrowing-down of the documents executed by the second narrowing-down unit 12 includes filtering using a keyword, as will be described later, this processing will be also referred to as filtering processing 62. The integrating narrowing-down unit 13 controls the first narrowing-down unit 11 and the second narrowing-down unit 12. The integrating narrowing-down unit 13 implements a retrieval phase that is the first half of retrieval-augmented generation (RAG).

The response generating unit 14 generates a response 56, as a response to an inquiry from the user, using the second narrowed-down documents 82. The response generating unit 14 implements a generation phase that is the second half of the RAG. The DB creating unit 17 creates a chunk DB 91, a vector DB 92, a metadata DB 93, and a keyword DB 94. The GUI processing unit 18 implements interaction with the user. The document set communicating unit 19 implements communication for reading the document set 80 stored external of the computing device 1. The language model communicating unit 20 implements communication with the large-scale language model 2 located external of the computing device 1.

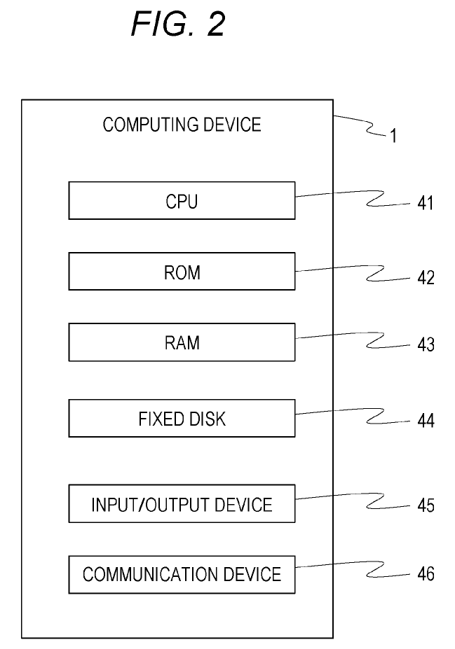

FIG. 2 is a hardware configuration diagram of the computing device 1. The computing device 1 includes CPU 41 that is a central processing unit, a ROM 42 that is a read-only memory, a RAM 43 that is a readable/writable memory, a fixed disk 44, an input/output device 45 that is a user interface, and a communication device 46. The CPU 41 executes various kinds of operations described above by loading a program stored in the ROM 42 onto the RAM 43 and executing the program. The computing device 1 may also be implemented as a field-programmable gate array (FPGA) that is a rewritable logic circuit, or an application-specific integrated circuit (ASIC), instead of the combination of the CPU 41, the ROM 42, and the RAM 43. The computing device 1 may also be implemented as a different combination of the elements, such as a combination of the CPU 41, the ROM 42, the RAM 43, and an FPGA, instead of the combination of the CPU 41, the ROM 42, and the RAM 43.

The fixed disk 44 is a nonvolatile storage device such as a hard disk drive. Examples of the input/output device 45 include a mouse, a keyboard, and a liquid crystal display. The input/output device 45 may also be a touch panel in which a mouse and a liquid crystal display are integrated, or it is also possible for the input/output device 45 not to include a keyboard. The communication device 46 is a communication module capable of at least one of wireless and wired communication. In FIG. 2, for the sake of convenience, the computing device 1 is illustrated as being implemented as one hardware device, but the computing device 1 may also be implemented as a plurality of hardware devices. In such a case, the hardware devices may be installed adjacent to each other, or may be connected via a local area network or the Internet.

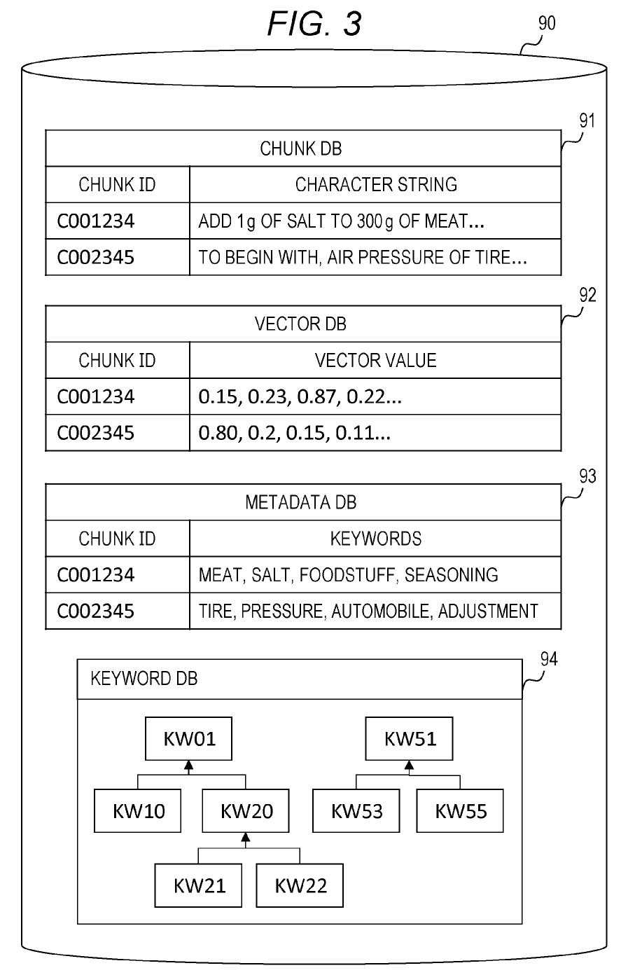

FIG. 3 is a diagram illustrating an example of data stored in databases. The master database 90 includes the chunk database 91, the vector database 92, the metadata database 93, and the keyword database 94. Each of these databases included in the master database 90 is created by the DB creating unit 17. The chunk database 91 stores therein data identifying each chunk. For example, in the example illustrated in FIG. 3, a corresponding relationship between a chunk ID and a character string is illustrated. It is also possible to use, instead of a character string, a combination of a document ID and a paragraph number, for example. The vector database 92 stores therein a vector value for each chunk. For example, the vector database 92 stores therein a combination of a chunk ID and a vector value.

The metadata database 93 stores therein a keyword for each chunk. For example, the metadata database 93 stores therein a combination of a chunk ID and a keyword. In the example illustrated in FIG. 3, two keywords are associated with each chunk. However, there is no upper limit to the number, as long as at least one keyword is associated with each chunk. The keyword database 94 stores therein keyword hierarchy data. In the example illustrated in FIG. 3, a hierarchy of keywords is visually illustrated for the ease of understanding, but there is no limitation to the way in which data is stored, as long as a computer can understand the hierarchy. In the example illustrated in FIG. 3, KW01 is the root keyword, KW10 and KW20 are children of KW01, and KW21 and KW22 are children of KW20. It can be said that the relationship between keywords of higher and lower order represents a relationship between abstraction and concretization.

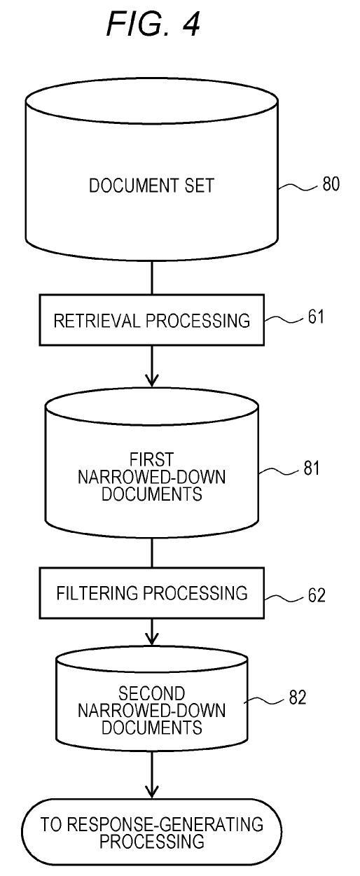

FIG. 4 is a diagram illustrating a correlation relationship between pieces of data. Specifically, FIG. 4 illustrates a relationship between the document set 80, the first narrowed-down documents 81, and the second narrowed-down documents 82. The document set 80 includes various unstructured documents collected in advance. The documents included in the document set 80 are not limited to any particular documents. Users can add a document to the document set 80, as will be described later. In the description herein, a “document” is a collection of character strings that are understandable by humans. The first narrowed-down documents 81 form a subset of the document set 80. The first narrowed-down documents 81 are documents extracted from the document set 80, as a result of the retrieval processing 61, to be described later. The second narrowed-down documents 82 form a subset of the first narrowed-down documents 81. The second narrowed-down documents 82 are documents extracted from the first narrowed-down documents 81, as a result of the filtering processing 62, to be described later. In other words, the second narrowed-down documents 82 are documents obtained by narrowing down the document set 80 twice.

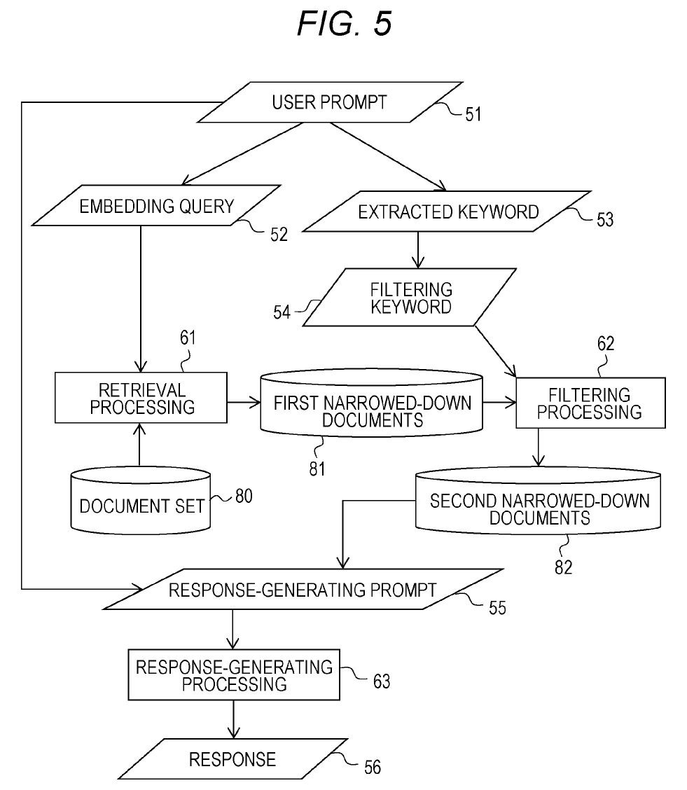

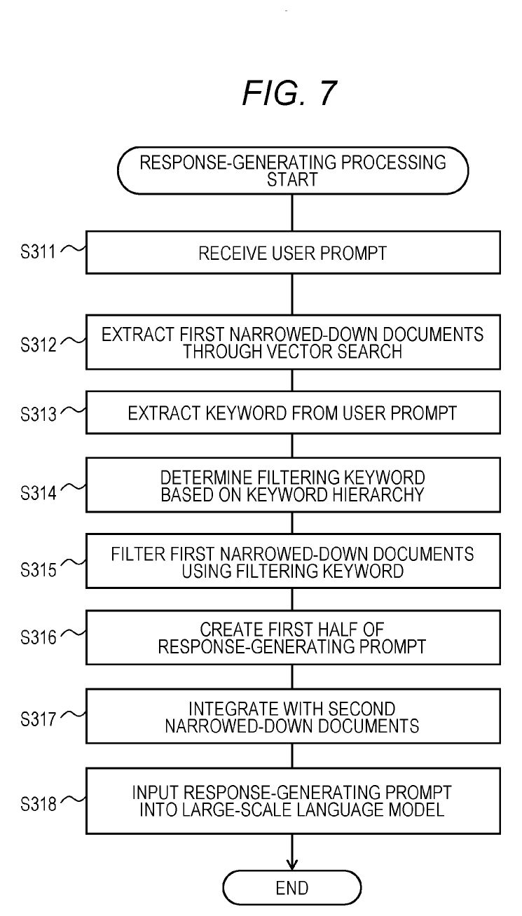

FIG. 5 is a diagram illustrating a correlation between data and processing, involved in response-generating processing 63 executed by the computing device 1. The flowchart corresponding to this drawing is illustrated in FIG. 7, as will be described later. A starting point of the response-generating processing 63 is a user prompt 51 that is a question entered by a user. Using this user prompt 51, an embedding query 52, an extracted keyword 53, and a part of a response-generating prompt 55 are generated. The embedding query 52 is a vectorization of the user prompt 51. The extracted keyword 53 is a keyword extracted from the user prompt 51.

The embedding query 52 is used in the retrieval processing 61, which has been mentioned in the description of FIG. 4. As a result of this retrieval processing 61, the first narrowed-down documents 81 are extracted from the document set 80. The extracted keyword 53 is used in determining a filtering keyword 54, as will be described later. The filtering keyword 54 is used in the filtering processing 62, which has been mentioned in the description of FIG. 4. Through the filtering processing 62, the first narrowed-down documents 81 are narrowed down into the second narrowed-down documents 82. The response-generating prompt 55 is a combination of a character string generated from the user prompt 51 and the second narrowed-down documents 82. The response-generating prompt 55 is used in the response-generating processing 63. The response-generating processing 63 outputs a response 56.

Note that the drawing prioritizes the ease of understanding, and therefore is not accurate, strictly speaking, in the following points. Generation of the embedding query 52 is included in the retrieval processing 61. Generation of the extracted keyword 53 and generation of the filtering keyword 54 are included in the filtering processing 62. Generation of the response-generating prompt 55 is included in the response-generating processing 63.

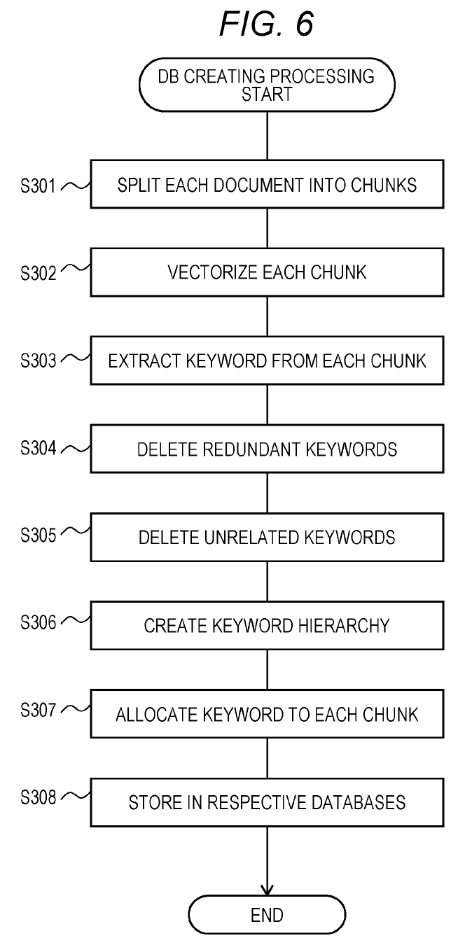

FIG. 6 is a flowchart illustrating database creating processing performed by the DB creating unit 17. In step S301, the DB creating unit 17 splits each document included in the document set 80 into chunks. For example, the DB creating unit 17 splits each document in units of a paragraph or a sentence. In subsequent step S302, the DB creating unit 17 vectorizes each of the chunks formed in step S301. This step may be implemented by using a program that uses a punctuation or a line feed as a chunk delimiter, or it is also possible to use the large-scale language model 2.

In subsequent step S303, the DB creating unit 17 extracts a keyword from each of such chunks, using the keyword extracting unit 10. In subsequent step S304, the DB creating unit 17 deletes redundant keywords from the keywords extracted in step S303. In the redundancy detection, preferably, not only phrase matching but also semantic matching is used. For example, “car” and “automobile” have the same meaning, so it is desirable to delete one of these two.

In subsequent step S305, the DB creating unit 17 deletes keywords that are not related to a subject. One or more subjects may be set in advance, or one or more subjects may be set on the basis of the extracted keywords. Examples of the subject include “cooking”, “car repair”, and “celestial observation”. If there is more than one subject, transition to this step is repeated in the same number of times as the number of subjects. Hereinafter, a keyword remaining without being deleted in this step will be referred to as a “unique keyword”. In subsequent step S306, the DB creating unit 17 creates a keyword hierarchy including all of such unique keywords. This keyword hierarchy may be created using the large-scale language model 2, for example.

In subsequent step S307, the DB creating unit 17 allocates keywords to each of the chunks. Specifically, the DB creating unit 17 allocates the keyword extracted in step S303 and ancestor keywords of the extracted keyword, to each of the chunks. For example, assuming an example of the keyword DB 94 illustrated in FIG. 3, if KW22 is extracted from a certain chunk, the DB creating unit 17 allocates three keywords KW01, KW20, and KW22 to the chunk. If KW51 is extracted from another chunk, the DB creating unit 17 allocates KW51 to the chunk.

In subsequent step S308, the DB creating unit 17 stores the calculation results in the respective databases, and ends the processing illustrated in FIG. 6. Specifically, the DB creating unit 17 stores each chunk calculated in step S301 in the chunk database 91. The DB creating unit 17 also stores the vector of each chunk calculated in step S302 in the vector database 92. The DB creating unit 17 also stores a corresponding relationship between the chunk and the keyword calculated in step S307 in the metadata database 93. The DB creating unit 17 also stores the data related to the keyword hierarchy calculated in step S306, in the keyword database 94.

FIG. 7 is a flowchart illustrating the response-generating processing 63 executed by the computing device 1. Before the processing illustrated in this flowchart is started, the DB creating processing has been completed in advance. This flowchart is executed when the user enters a user prompt 51 using the input/output device 45. This flowchart includes steps S311 to S316. Steps S311 to S315 are executed by the first narrowing-down unit 11 and the second narrowing-down unit 12, under the control of the integrating narrowing-down unit 13. The last step S316 is executed by the response generating unit 14.

To begin with, in step S311, the first narrowing-down unit 11 receives the user prompt 51. In subsequent step S312, the first narrowing-down unit 11 extracts the first narrowed-down documents 81 through vector search that uses the user prompt 51. For example, the first narrowing-down unit 11 generates an embedding query 52 by vectorizing the user prompt 51 and retrieves the vector database 92 for vectors similar to the embedding query 52, to obtain the first narrowed-down documents 81. The similarity between the vectors can be evaluated using cosine similarity or Euclidean distance, for example.

In subsequent step S313, the second narrowing-down unit 12 extracts a keyword from the user prompt 51 using various known methods. The keyword extracted in this step will be referred to as an extracted keyword 53. The extracted keyword 53 is a character string included in the user prompt 51. In subsequent step S314, the second narrowing-down unit 12 determines a keyword to be used for filtering, on the basis of the extracted keyword 53 and the keyword database 94. The keyword determined in this step will be referred to as a filtering keyword 54, for the purpose of distinguishing this keyword from other keywords. For example, the second narrowing-down unit 12 determines a keyword having the closest meaning to the extracted keyword 53, from the keywords listed in the keyword database 94, as the filtering keyword 54.

In subsequent step S315, the second narrowing-down unit 12 applies filtering to the first narrowed-down documents 81 using the filtering keyword 54, to obtain the second narrowed-down documents 82. Specifically, the second narrowing-down unit 12 establishes the chunks associated with the filtering keyword 54 in the metadata DB 93, among those of the first narrowed-down documents 81, as the second narrowed-down documents 82. In subsequent step S316, the response generating unit 14 creates a first half of the response-generating prompt 55 using the user prompt 51. The response generating unit 14 may create this first half using the rule-based approach or using the large-scale language model 2. In the case of the rule-based approach, “Please answer by referring to the following documents” may be added after the user prompt 51.

In subsequent step S317, the response generating unit 14 integrates the first half of the response-generating prompt 55 generated in step S316 with the second narrowed-down documents 82, to obtain a response-generating prompt 55. In subsequent step S318, the response generating unit 14 inputs the response-generating prompt 55 to the large-scale language model 2, receives the output from the large-scale language model 2 as a generation result, and ends the processing illustrated in FIG. 7.

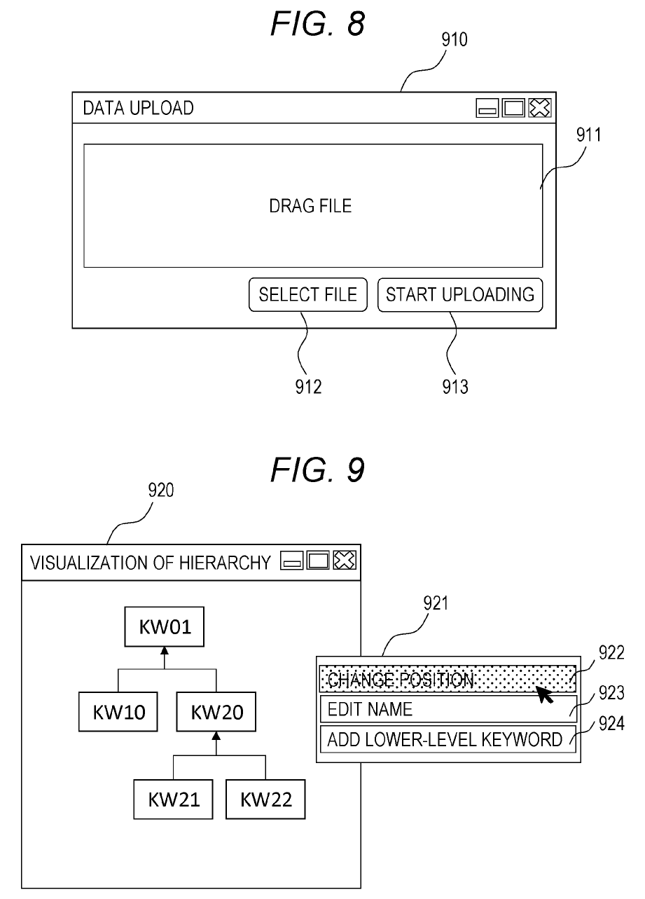

FIGS. 8 to 10 are diagrams illustrating examples of interaction with the user by the GUI processing unit 18. FIG. 8 is a diagram illustrating how new data is added to the document set 80. A data upload window 910 illustrated in FIG. 8 includes a drag file field 911, a select file button 912, and a start upload button 913. The data upload window 910 is displayed on a liquid crystal display included in the input/output device 45 or a display of a terminal connected via the communication device 46. A file dragged into the drag file field 911 by the user or a file selected using a file selection dialog that appears in response to a pressing operation of the select file button 912 is to be uploaded. When the start upload button 913 is pressed, the file to be uploaded is added to the document set 80 by the GUI processing unit 18. When a document is added to the document set 80, the processing of the DB creating unit 17 is started.

The keyword edit window 920 illustrated in FIG. 9 includes a hierarchized keyword display area 928 and an edit window 921. In the hierarchized keyword display area 928, the keywords stored in the keyword DB 94 are displayed in a hierarchical structure. When the user selects any one of the keywords, an edit window 921 appears. The edit window 921 includes a Change position button 922, an Edit name button 923, and an Add keyword button 924. When the Change position button 922 is pressed, a change in the position of a keyword, that is, an operation for moving the keyword between the classes is accepted from the user, and the keyword DB 94 is updated by the GUI processing unit 18. When the Edit name button 923 is pressed, a change in the name change of the keyword by the user is accepted, and the keyword DB 94 is updated by the GUI processing unit 18. When the Add keyword button 924 is pressed, addition of a keyword is accepted from the user, and the GUI processing unit 18 updates the keyword DB 94.

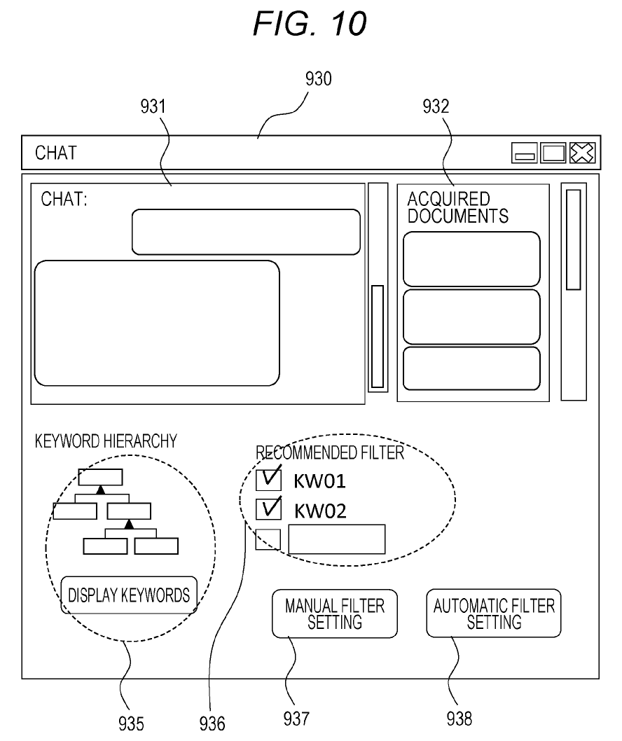

A detail designating window 930 illustrated in FIG. 10 includes an input/output area 931, a used document display area 932, a keyword hierarchy display area 935, and a filtering keyword display area 936. In the input/output area 931, the user prompt 51 entered by the user and the response 56 output from the response generating unit 14 are displayed. In the used document display area 932, the second narrowed-down documents 82 are displayed. In the keyword hierarchy display area 935, the keywords stored in the keyword DB 94 are displayed in a hierarchical structure. In the filtering keyword display area 936, the filtering keyword 54 determined by the second narrowing-down unit 12 is displayed.

In the example illustrated in FIG. 10, “KW01” and “KW02” are determined as the filtering keywords 54. The user can then reduce the number of the filtering keywords 54 by unchecking the check boxes on the left side of “KW01” and “KW02”. The user may add any keyword to a space blank under “KW02”. When the user makes an input to a check box or a blank, and presses a manual filter setting button 937, the second narrowed-down documents 82 are determined using the filtering keyword 54 changed by the user, and the response 56 is regenerated.

According to the first embodiment described above, the following actions and effects can be achieved:
(1) A computing device 1 includes: a document set communicating unit 19 that is capable of accessing a document set 80 including a plurality of documents collected in advance; a metadata DB 93 specifying a corresponding relationship between each of the documents included in the document set 80 and a keyword that is at least one word; a keyword extracting unit 10 that extracts an extracted keyword 53 that is a word from a user prompt 51 that is a question entered by a user; a first narrowing-down unit 11 that narrows down the documents in the document set 80, on the basis of similarity between the user prompt 51 and the documents; a second narrowing-down unit 12 that narrows down the documents in the document set 80, on the basis of the extracted keyword 53 and the metadata DB 93; and an integrating narrowing-down unit 13 that narrows down the documents in the document set 80, using the first narrowing-down unit 11 and the second narrowing-down unit 12. Therefore, it is possible to improve the retrieval of a document related to the user prompt 51.
(2) The computing device 1 includes a response generating unit 14 that generates a response to the user prompt 51, on the basis of second narrowed-down documents 82 that are documents narrowed-down by the integrating narrowing-down unit 13, and the user prompt 51. Therefore, a response can be generated using the second narrowed-down documents 82 obtained by the integrating narrowing-down unit 13. Because the second narrowed-down documents 82 are extracted from the document set 80 through the vector search and the filtering processing 62 using the keyword, the second narrowed-down documents 82 are highly related to the user prompt 51, so that the response generating unit 14 can output an accurate response.
(3) The computing device 1 includes a DB creating unit 17 that creates a keyword DB 94. Therefore, when the user adds a document, the master DB 90 including the keyword DB 94 can be created again.
(4) The computing device 1 includes a keyword DB 94 specifying a hierarchical relationship among keywords that are associated with the document set 80. The second narrowing-down unit 12 identifies a word having a meaning closest to the extracted keyword 53, from the words in the keyword DB 94, and establishes the word as the filtering keyword 54. Therefore, even if the user prompt 51 does not include any keyword specified in the keyword DB 94, the processing can be performed using the keyword having the closest meaning.

### First Modification

In the first embodiment described above, the filtering processing 62 is performed after the retrieval processing 61. However, these runs of processing may be performed in the opposite order. That is, filtered documents 81A may be obtained by applying the filtering processing 62 to the document set 80, and the second narrowed-down documents 82 may be obtained by applying the retrieval processing 61 to the filtered documents 81A as a population.

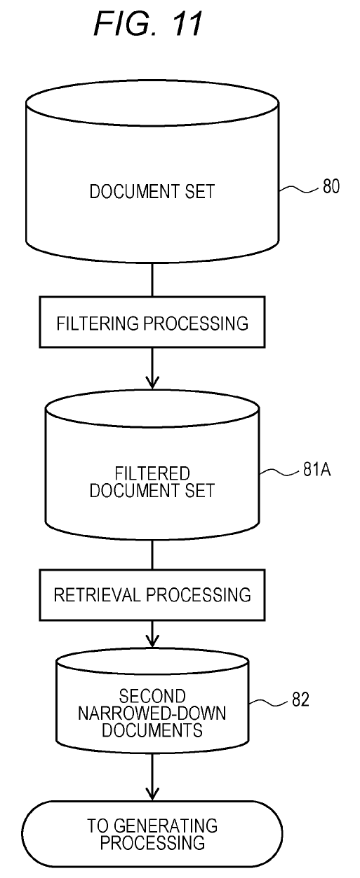

FIG. 11 is a diagram illustrating a correlation relationship between pieces of data in the first modification. The first modification is different from the first embodiment illustrated in FIG. 4 in that the retrieval processing 61 and the filtering processing 62 are swapped, and the first narrowed-down documents 81 are changed to the filtered documents 81A. The first embodiment and this modification have no difference in the retrieval processing 61 and the filtering processing 62 but are different in targets to which the processing is applied. This modification is implemented by changing the targets to be processed by the first narrowing-down unit 11 and the second narrowing-down unit 12, designated thereto by the integrating narrowing-down unit 13.

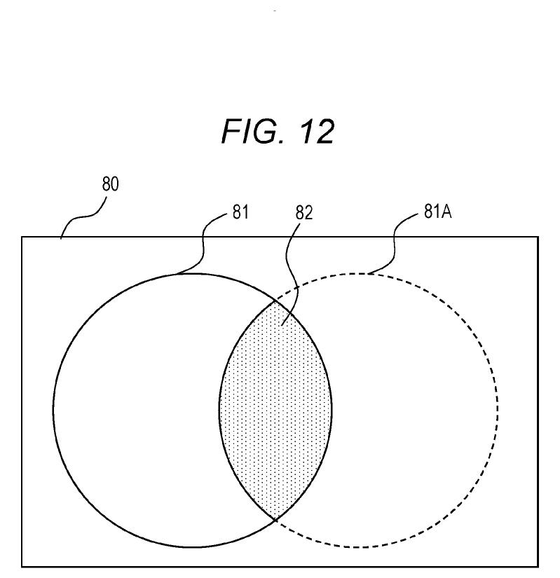

FIG. 12 is a diagram illustrating a correlation between pieces of data in the first embodiment and the first modification. The outer square indicates the document set 80, the solid-line circle indicates the first narrowed-down documents 81, the dashed-line circle indicates the filtered documents 81A, and the hatched area at the center indicates the second narrowing-down unit 12. The retrieval processing 61 is processing for extracting the first narrowed-down documents 81 from the document set 80. The filtering processing 62 is processing for extracting the filtered documents 81A from the document set 80. The common part between the first narrowed-down documents 81 and the filtered documents 81A, that is, the intersection therebetween corresponds to the second narrowed-down documents 82. Therefore, the second narrowed-down documents 82 may be obtained by a third method other than the method according to the first embodiment or this modification. In other words, each of the first narrowed-down documents 81 and the filtered documents 81A may be extracted independently from the document set 80, and the intersection between the first narrowed-down documents 81 and the filtered documents 81A may be established as the second narrowed-down documents 82.

### Second Modification

In the first embodiment described above, the second narrowing-down unit 12 sets the calculated filtering keyword 54 immediately. However, the second narrowing-down unit 12 may inquire the user before the filtering processing 62 is executed using the filtering keyword 54.

### Third Modification

The processing performed by the GUI processing unit 18 illustrated in FIGS. 8 to 10 is not an essential configuration. It is therefore possible for the computing device 1 not to include the GUI processing unit 18. In this case, for example, the user prompt 51 is input from the external via the communication device 46, and the output from the response generating unit 14 is further output to the external via the communication device 46.

### Fourth Modification

In the first embodiment described above, the computing device 1 includes the response generating unit 14. However, it is also possible for the computing device 1 not to include the response generating unit 14, and the user prompt 51 and the second narrowed-down documents 82 may be provided to another device, and the other device may be caused to generate the response 56.

### Second Embodiment

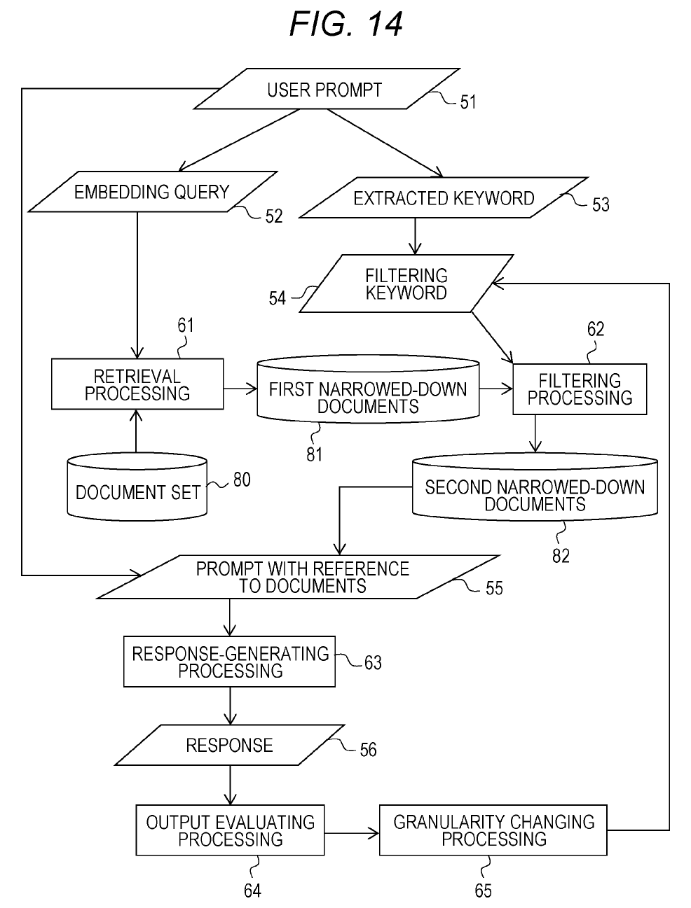

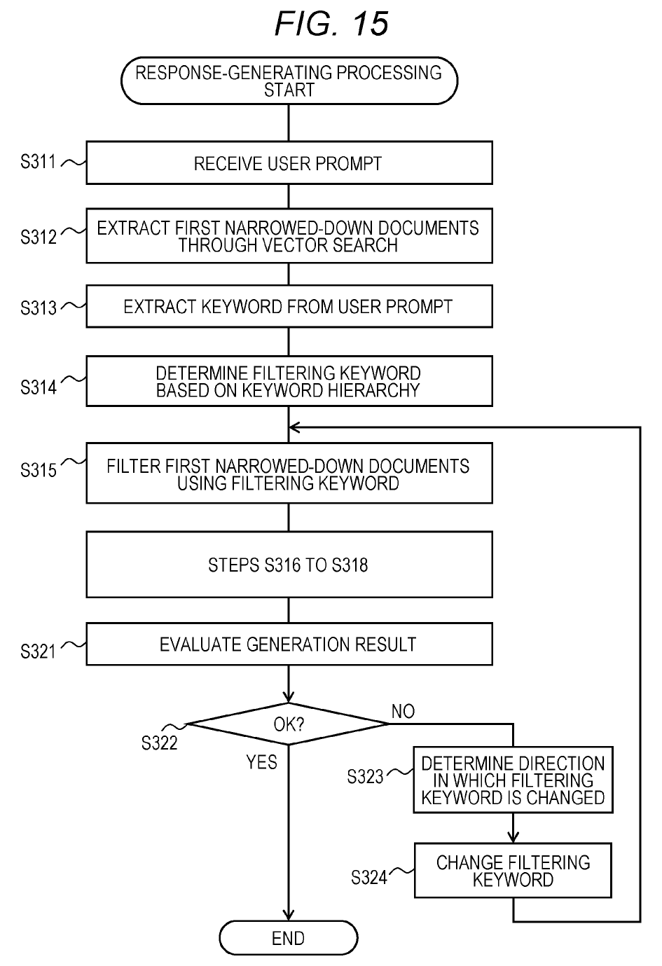

A computing device and a computing method according to a second embodiment will now be described with reference to FIGS. 14 to 15. In the following description, the same components as those in the first embodiment are given the same reference numerals, and differences will be mainly explained. The points not specifically described hereunder are the same as those in the first embodiment. This embodiment is different from the first embodiment mainly in that the filtering keyword 54 is corrected.

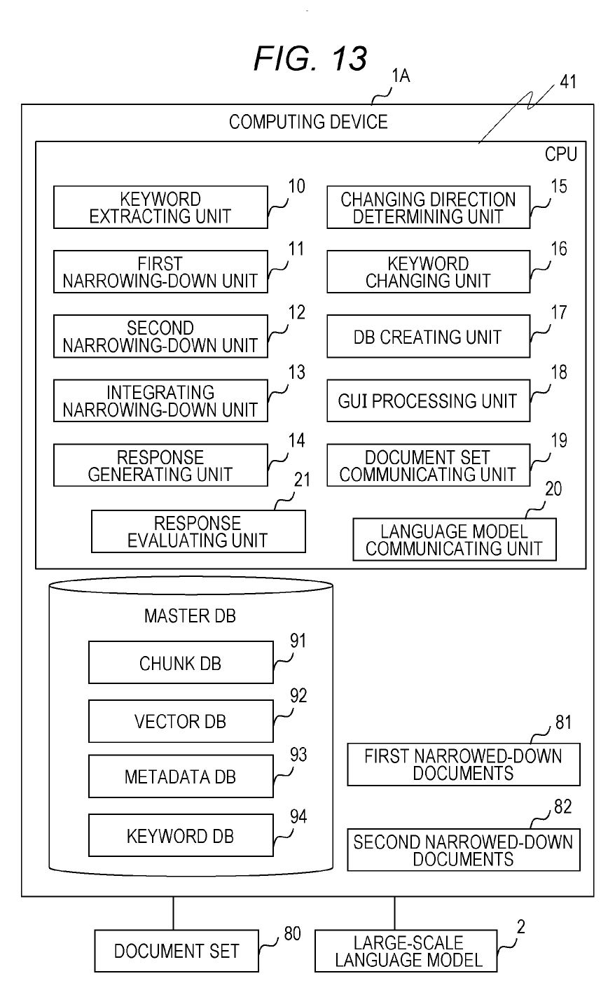

FIG. 13 is a functional configuration diagram of a computing device 1A. The computing device 1A further includes a changing direction determining unit 15, a keyword changing unit 16, and a response evaluating unit 21, in addition to the entire configuration of the computing device 1 according to the first embodiment. The response evaluating unit 21 determines whether the response 56 is an output in accordance with the user's request. The changing direction determining unit 15 determines whether the keyword is to be concretized or abstracted, when the keyword is to be changed. The keyword changing unit 16 specifically changes the keyword on the basis of the determination made by the changing direction determining unit 15.

FIG. 14 is a diagram illustrating correlation between data and processing, involved in response-generating processing 63 executed by the computing device 1A. The difference from the first embodiment illustrated in FIG. 5 is in that output evaluating processing 64 and granularity changing processing 65 are additionally provided. In this embodiment, the response 56 is evaluated in the output evaluating processing 64. When it is determined that the response 56 is insufficient, the filtering keyword 54 is changed in the granularity changing processing 65. The filtering processing 62 is then executed again using the new filtering keyword 54, and the response-generating processing 63 is executed using new second narrowed-down documents 82. The entity that executes the output evaluating processing 64 is the response evaluating unit 21, and the entities that execute the granularity changing processing 65 are the changing direction determining unit 15 and the keyword changing unit 16.

FIG. 15 is a flowchart illustrating response-generating processing 63 according to the second embodiment. This flowchart is different from that illustrated in FIG. 7 according to the first embodiment in that steps S321 to S323 are added and the loop returns to immediately before step S315. Because processing in steps S311 to S318 is similar to that according to the first embodiment, description thereof will be omitted. Although details of steps S316 to S318 are not illustrated for the convenience of illustration, these processes are the same as those in the first embodiment.

In step S321 executed after step S318, the response evaluating unit 21 evaluates the generated result. For example, the large-scale language model 2 may be used to make this evaluation. In other words, an evaluation prompt including the prompt obtained in step S311 and the generation result generated in step S316 is generated, and the large-scale language model 2 determines whether the output is appropriate. For example, an evaluation prompt “Is an answer yyy appropriate for an inquiry xxx? Please answer YES or NO.” is generated. Note that xxx is substituted with the prompt acquired in step S311, and yyy is substituted with the generation result generated in step S316.

In subsequent step S322, the changing direction determining unit 15 makes a determination for the evaluation result in step S321. If the changing direction determining unit 15 determines that the evaluation result is positive, e.g., is sufficient as an answer, the processing illustrated in FIG. 15 is ended. If the evaluation result is negative, e.g., is an inappropriate answer, the processing is shifted to step S323. In step S323, the changing direction determining unit 15 determines the direction in which the filtering keyword 54 is to be changed, that is, either in the direction of abstraction or concretization. The direction in which the filtering keyword 54 is changed may be determined on the basis of an output obtained by inputting a created determination prompt to the large-scale language model 2, for example.

An example of the determination prompt may be “In response to the inquiry xxx, an answer yyy has been obtained by referring to the documents zzz. To improve the answer, which do you prefer, to decrease or to increase the number of documents to be referred to?” xxx and yyy are as described above, and zzz is substituted with the current second narrowed-down documents 82.

In subsequent step S324, the keyword changing unit 16 changes the filtering keyword 54 on the basis of the direction of change determined in step S323 and the keyword database 94 and goes back to step S315. Once the filtering keyword 54 is changed in step S324, the second narrowed-down documents 82 generated in step S315 change, the processing result in step S316 also changes, so that it is expected that the evaluation result in step S321 improves. Note that, if it is not possible to change the keyword in step S324, the processing may be ended by displaying that the keyword cannot be changed. Examples of a case in which the keyword cannot be changed include a case in which the keyword is to be changed in the direction of abstraction although the root keyword has been already selected, and a case in which the keyword is to be changed in the direction of concretization although a leaf keyword has been already selected.

According to the second embodiment described above, the following actions and effects can be achieved.

(5) A keyword DB 94 specifying a hierarchical relationship among the keywords associated with the document set 80 is provided. Included are: a changing direction determining unit 15 that determines whether to reduce the number of the second narrowed-down documents 82 to improve the response; and a keyword changing unit 16 that makes the keyword used by the second narrowing-down unit 12 more specific or more abstract, on the basis of the determination made by the changing direction determining unit 15. Therefore, feedback for improving the second narrowed-down documents 82 can be provided.

(6) The integrating narrowing-down unit 13 causes the first narrowing-down unit 11 to narrow down the documents in the document set 80 into the first narrowed-down documents 81. The second narrowing-down unit 12 narrows down the first narrowed-down documents 81. When the keyword changing unit 16 changes the keyword, the integrating narrowing-down unit 13 causes the second narrowing-down unit 12 to narrow down the first narrowed-down documents 81 again. Therefore, even if the keyword is changed, it is not necessary to cause the first narrowing-down unit 11 to execute the retrieval processing 61 again, and it is only necessary to execute the filtering processing 62, which is efficient.

### Modification of Second Embodiment

In step S323 in FIG. 15, the determination may be made on the basis of the number of documents, instead of using the large-scale language model 2. For example, a preferable range of the number of documents may be set in advance, and either abstraction or concretization may be selected so as to bring the second narrowed-down documents 82 closer to such a range.

In each of the embodiments and modifications described above, the configuration of the functional blocks is merely an example. Some of the functional units illustrated as separate functional blocks may be integrated, or a configuration illustrated as one functional block diagram may be divided into two or more functions. In addition, some of the functions of any one of the functional blocks may be included in another.

In the embodiments and modifications described above, the programs have been described as being stored in the ROM, not illustrated, but the programs may also be stored in the fixed disk 44. Furthermore, the computing device 1 may include an input/output interface, not illustrated, and a program may be read from another device via a medium usable by the input/output interface and the computing device 1, as required. The medium herein refers to a storage medium removable from the input/output interface, or a communication medium, that is, a wired, wireless, or optical network, or a carrier wave or a digital signal propagating through the network, for example. Some or all of the functions implemented by a program may be implemented by a hardware circuit or an FPGA.

The embodiments and modifications described above may be combined. Although various embodiments and modifications have been described above, the present invention is not limited thereto. Other aspects conceivable within the scope of the technical idea of the present invention still fall within the scope of the present invention.

1. A computing device comprising:
a processor that executes a program;
a storage device that stores the program; and
a document set communicating unit that is capable of accessing a document set including a plurality of documents collected in advance, wherein
the storage device further stores a metadata DB specifying a corresponding relationship between each of the documents included in the document set and a keyword that is at least one word, and
the processor is configured to perform:
keyword extracting processing of extracting an extracted keyword that is a word, from a user prompt that is a question entered by a user;
first narrowing-down processing of narrowing down the documents in the document set based on similarity between the user prompt and the documents;
second narrowing-down processing of narrowing down the documents in the document set based on the extracted keyword and the metadata DB; and
integrated narrowing-down processing of narrowing down the documents in the document set using the first narrowing-down processing and the second narrowing-down processing.

2. The computing device according to claim 1, wherein the processor is further configured to execute response-generating processing of generating a response to the user prompt, based on an integrated narrowed-down document that is a document resultant of the integrated narrowing-down processing and on the user prompt.

3. The computing device according to claim 2, wherein
the storage device further stores a keyword DB specifying a hierarchical relationship among keywords associated with the document set, and
the processor is further configured to perform:
change direction determining processing of determining whether to reduce the integrated narrowed-down documents to improve the response; and
keyword changing processing of concretizing or abstracting the keyword used in the second narrowing-down processing based on a determination made in the change direction determination processing.

4. The computing device according to claim 3, wherein the processor is further configured:
in the integrated narrowing-down processing, to obtain first narrowed-down documents that are documents resultant of narrowing down the documents in the document set using the first narrowing-down processing, and to perform the second narrowing-down processing on the first narrowed-down documents; and
when the keyword is changed in the keyword changing processing, to perform the second narrowing-down processing again on the first narrowed-down documents.

5. The computing device according to claim 3, wherein the processor is further configured to perform keyword DB creating processing of creating the keyword DB.

6. The computing device according to claim 1, wherein
the storage device further stores a keyword DB specifying a hierarchical relationship among keywords associated with the document set, and
the processor is further configured to identify, in the second narrowing-down processing, a word having a meaning closest to the extracted keyword from the keyword DB, and to set the word thus identified as a filtering keyword.

7. A computing method executed by a computer including: a document set communicating unit that is capable of accessing a document set including a plurality of documents collected in advance; and a metadata database specifying a corresponding relationship between each of the documents included in the document set and at least one keyword, the computing method comprising:
keyword extracting processing of extracting an extracted keyword that is a word, from a user prompt that is a question entered by a user;
first narrowing-down processing of narrowing down the documents in the document set based on similarity between the user prompt and the documents;
second narrowing-down processing of narrowing down the documents in the document set based on the extracted keyword and keywords associated with the documents; and
integrated narrowing-down processing of narrowing down the documents in the document set using the first narrowing-down processing and the second narrowing-down processing.
